(19) United States
(12) Patent Application Publication
(10) Pub. No.: US 2019/0079467 A1
(43) Pub. Date: Mar. 14, 2019

(54) EVOLVING COMPUTER-BASED REASONING SYSTEMS

(71) Applicant: Diveplane Corporation, Raleigh, NC (US)

(72) Inventor: CHRISTOPHER JAMES HAZARD, Durham, NC (US)

(21) Appl. No.: 15/703,894

(22) Filed: Sep. 13, 2017

(51) Int. Cl. G05B 13/02; G06F 17/15

(52) U.S. Cl. CPC G05B 13/024; G06N 99/005; G06F 17/15

(57) ABSTRACT

Techniques are provided herein for evolving computer-based reasoning system and include receiving a first training context-action pair that includes at least one first executable context element; receiving a second training context-action pair; evolving a candidate context-action pair based at least in part on the first training context-action pair and the second training context-action pair; testing whether a set of candidate context-action pairs (that includes candidate context-action pair) meets exit criteria; and when the set of candidate context-action pairs meets the exit criteria, selecting the set of candidate context-action pairs as an evolved set of candidate-action pairs.

### FIELD OF THE INVENTION

The present invention relates to computer-based optimization and artificial intelligence techniques and in particular to evolving computer-based reasoning systems.

### BACKGROUND

Many systems are controlled by computer-based reasoning systems. A common issue with such systems, however, is that they are limited in functionality and execution to the training sets available. For example, if a computer-based reasoning system uses the training data from a single trainer, e.g., Alicia, then the computer-based reasoning system will only be able to rely on Alicia's training data in order to make decisions. Adding additional trainers may help, but the benefit is not guaranteed. For example, adding in the training set of another trainer, Bob, to the training set from Alicia will allow the system to choose between those two training sets in order to make decisions. Such a system may perform better than either Alicia or Bob. Selecting from among the training sets of the two may, at best, produce better results than for either one alone. There is no guarantee of that, however. If the approaches to the task of Alicia and Bob are incompatible or otherwise at odds, the result of combining the two could be worse than either one alone.

Techniques herein address these issues.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

Techniques are provided herein for evolving computer-based reasoning system and include receiving a first training context-action pair, wherein the first training context-action pair includes at least one first executable context element; receiving a second training context-action pair; evolving a candidate context-action pair based at least in part on the first training context-action pair and the second training context-action pair; testing whether a set of candidate context-action pairs meets exit criteria, wherein the set of candidate context-action pairs includes the candidate context-action pair; and when the set of candidate context-action pairs meets the exit criteria, selecting the set of candidate context-action pairs as an evolved set of candidate-action pairs.

In some embodiments, determining the candidate context-action pair based at least in part on the first training context-action pair and the second training context-action pair includes mutating a portion of the candidate context-action pair. Further, mutating the portion of the candidate context-action pair includes replacing the portion of the candidate context-action pair with a function; and the function may be calculated based on a second portion of the candidate context-action pair different from said portion of the candidate context-action pair.

In some embodiments, the candidate context-action pair includes at least one candidate executable context element, and optionally, the at least one candidate executable context element of the candidate context-action pair is determined based at least in part on the at least one first executable context element.

In some embodiments, determining the candidate context-action pair based at least in part on the first training context-action pair and the second training context-action pair includes selecting randomly between the first training context-action pair and the second training context-action pair.

In some embodiments, determining the candidate context-action pair based at least in part on the first training context-action pair and the second training context-action pair includes performing a resampling based at least in part on a context element of the first training context-action pair and a context element of the second training context-action pair.

In some embodiments, determining the candidate context-action pair based at least in part on the first training context-action pair and the second training context-action pair includes comparing modifiers associated with on the first training context-action pair and the second training context-action pair.

In some embodiments, testing whether the set of candidate context-action pairs meets the exit criteria includes determining a fitness score for the set of candidate context-action pairs.

In some embodiments, if the exit criteria are not met, the set of candidate context-action pairs is used as a training set, and is further evolved.

In some embodiments, the first training context-action pair and the second training context-action pair are part of one or more sets of training context-action pairs, and the techniques further include comparing two or more training context-action pairs in the one or more sets of training context-action pairs; and selecting the first training context-action pair and the second training context-action pair based at least in part on the comparison of the two or more training context-action pairs in the one or more sets of training context-action pairs.

### BRIEF DESCRIPTION OF THE DRAWINGS

In the drawings:

FIG. 1 depicts a process for evolving computer-based reasoning systems.

FIG. 2 depicts a process for selecting evolved computer-based reasoning systems.

FIG. 3 depicts a block diagram of a system for evolving computer-based reasoning systems.

FIG. 4 depicts additional example systems and hardware for evolving computer-based reasoning systems.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

When building a computer-based reasoning system, one may have many training cases from many different trainers, multiple training sets from the same trainer, etc. This can provide a good basis for allowing the system to mimic, in particular circumstances, what the trainers did in similar circumstances by matching current context to similar training contexts. Often, the trainers for the computer based reasoning systems will be experts. Combining the training cases of experts may yield good results, but that is not guaranteed. For example, it may seem clear that if there are two trainers, Alicia and Bob, combining the worst parts of Alicia's performance on a task with the worst part of Bob's will likely result in worse performance than either. On the other hand, combining the best part of Alicia's performance with the best part of Bob's might yield good results, but such a combination could still perform worse than either Alicia's or Bob's training set alone. For example, the combined results of the best portions of the two might yield poor results if the approaches of the two trainers are in conflict with one another. The techniques herein address these issues by evolving the training cases for a computer-based reasoning system, whether from an individual trainer or multiple trainers. In some embodiments, evolving the training data may include combining, mixing, or crossing over training data from one or more trainers in multiple ways in order to produce evolutionary experiments as well as mutating the training sets before and/or after the combination.

Using the technique herein, the training context-action pairs of one or more trainers may be evolved by combining context-action pairs of a single trainer or those of two or more trainers. Further, these context-action pairs may be mutated, either before or after combination. After creating a set of candidate context-action pairs, the set can be tested for fitness or may meet other exit criteria, and, subsequently, may be selected for later execution (e.g., as a reasoning engine for a self-driving car). These techniques can be used to make a set of evolved context-action pairs that perform better than any of the trainers were able to produce. In other words, the evolved set of context-action pairs may perform better (e.g., as determined by a fitness function, e.g.) than any of the training sets from any of the trainers, including performing better than a combination of the original training sets.

### Evolving Code for Computer-Based Reasoning Systems

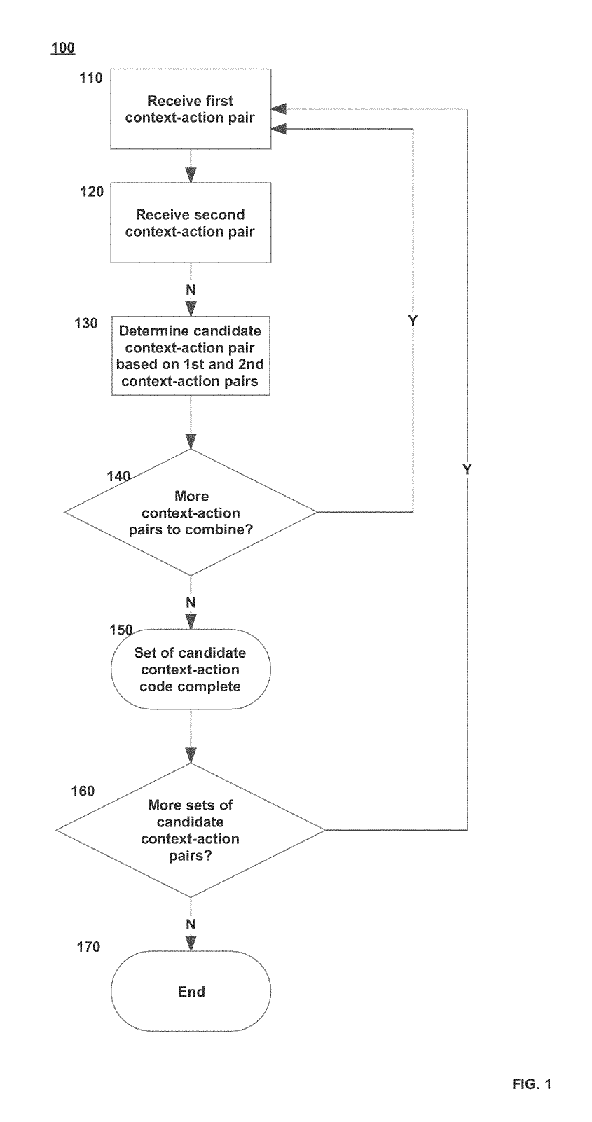

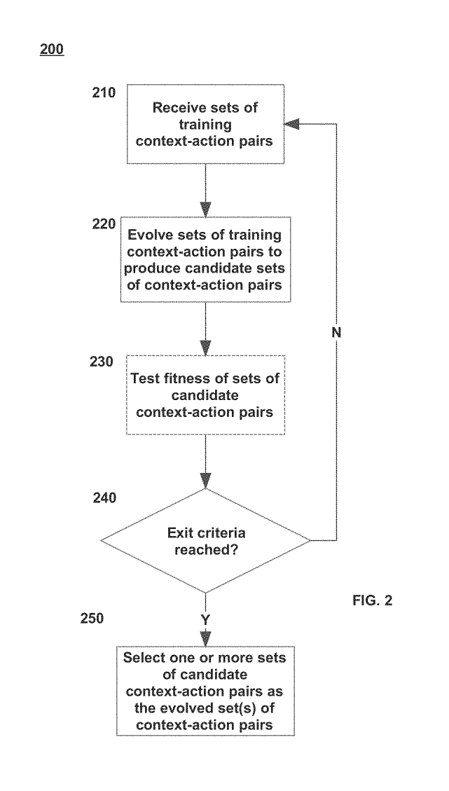

FIG. 1 depicts a process 100 for evolving code for computer-based reasoning systems. FIG. 1 is detailed below, but in general, FIG. 1 depicts a process in which a first candidate context-action pair is received 110, a second context-action pair is received 120, and candidate context-action pair(s) are determined 130 based on the first and second context-action pairs. The first and second candidate context-action pairs may be from the same training set, or from different training sets (e.g., two training sets from the same trainer, or two sets from different trainers). If 140 there are more context-action pairs to combine within a particular set of context-action pairs, then the process restarts with receiving 110 and 120. If not, then the set of candidate-action pairs are complete 150. If 160 there are more sets of context-action pairs to consider combining, then the process restarts, and otherwise, it the process ends 170. As discussed with respect to FIG. 2, the process of FIG. 1 can be part of a context in which one or more sets of context-action pairs are received 210, the one or more sets of context-action pairs are evolved 220 to produce a set (or more than one set) of candidate context-action pairs, and such evolution 220 may be performed using one or more aspects of process 100. The set(s) of candidate context-action pairs are optionally tested 230 for fitness, and when exit criteria is reached 240, one or more sets of the candidate context-action pairs are selected 250.

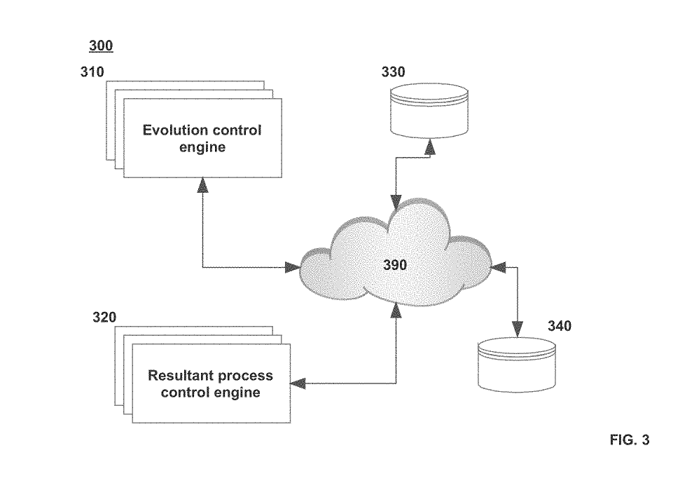

The first and second context-action pairs may be received 110 and 120 in the same way or in different ways. For example, each context-action pair may be received from an evolution control engine 310 of FIG. 3, or some other process, program, or system. The context-action pairs may be accessed from a memory in evolution control engine 310, attached storage 330 or 340, and may be received from a transmission over network 390.

The context-action pairs received 110 and 120 may be of identical form or different form. The context and action data can include any data that is pertinent to the decisions being made (e.g., the reasoning) in the system. If, for example, the reasoning system is being used for self-driving car control, the context data may include speed of vehicle; distance to light; location; position (lane) on the road; whether there are objects detected in front, on the sides, or behind the car (and the velocities, accelerations, and estimated identities of those objects, such as person, car, plastic bag, etc.); current speed; speed limit; direction of travel; next navigation instruction; whether the vehicle has a person inside; desired driving style of passenger; current acceleration; possible acceleration; distance the vehicle's sensors can detect; whether any obstructions to the sensors; as well as many others.

The context-action pair data can have been obtained in any appropriate manner and may be obtained in response to an event and/or obtained at regular intervals. For example, in some embodiments, the recording or saving of the context-action pair data may have been triggered on the vehicle being a certain distance from a turn, detection of an object in the road, etc. In some embodiments, more than one action is associated with a given context. For example, in the self-driving car example, when the next navigation instruction is to turn left, the actions to be taken may include switching a lane to the left (action 1) as well as slowing down the vehicle (action 2). Each of these actions may be associated with a similar or identical context and received 110 and 120 simultaneously or at different times. In some embodiments, the action associated with a context may be blank, empty, or NULL. For example, in some embodiments, when a context-action pair is recorded based on passage of a particular period of time (e.g., based on elapsed time since the occurrence of the last recorded context-action pair), there may be no action to associate with a context and, therefore, the action in the context-action pair may be blank, empty, or NULL. In such embodiments, time since last recoded event may be part of the context in the context-action pair.

In some embodiments, the action to be taken can be part of the context for the current action, or is part of context-action pairs for subsequent actions. For example, the context of a left turn in a self-driving car may include that a previous context-action training data pair included slowing down, and the current context may include switching to the left lane after the slowing of the car has already occurred.

In some embodiments, the training cases received may have been selected (not shown in FIG. 1) based on closeness criteria, compatibility criteria, etc.

After receiving 110 and 120 the context-action pairs, a candidate context-action pair is determined 130 based on the first and second context-action pairs. Determining 130 a candidate context-action pair from the first and second context-action pairs can take many forms. Further, a candidate context-action pair may be determined from a single training context-action pair, from two, three, or more training context-action pairs, etc. In some embodiments, more than two candidate context-action pairs may be determined based on the one or more training context-action pairs. For example, the techniques described with respect to determining 130 and elsewhere herein could be used to produce two or more candidate context-action pairs from either or both of the context-action pairs received 110 and 120, from other or additional context-action pairs, including being based on more than two context-action pairs. Determining 130 a context-action pair may also be termed ‘evolving’ 130 a context-action pair.

In many of the examples herein, the context-action pairs of two trainers, Alicia and Bob, are compared, selected, and/or combined to determine 130 the candidate context-action pair. In some embodiments, the training sets of context-action pairs all come from a single trainer (e.g., Alicia or Bob), or more than two trainers (e.g., Alicia, Bob, Charles, etc.) In the embodiments where the training sets being evolved are from a single trainer, similar training context-action pairs may be combined and evolved. For example, Alicia's set of training context-action pairs might include many left turns (actions) paired with numerous contexts. In some embodiments, the left turn training context-action pairs might be compared, a subset of those selected for combination, and then the selected subset of context-action pairs might be combined and/or evolved as discussed herein. Additionally, in some embodiments, there may be multiple sets of training context-action pairs for a single trainer. In such embodiments, the multiple training sets may be compared, selected, and combined in a manner similar to what is described herein for multiple training sets from multiple trainers.

As discussed, the techniques herein also apply to training context-action pairs of more than two trainers (e.g., Alicia, Bob, Charles, etc.). Consider for example, four sets of training context-action pairs for Alicia, Bob, Charles, and Diane. The techniques herein may combine the training context-action pairs from any combination of Alicia, Bob, Charles, and Diane with those of Alicia, Bob, Charles, and Diane, including comparing, selecting, and combining training context-action pairs of one trainer with those of the same trainer as described in the single-trainer context. When there are more than two training sets, the training sets from the trainers may be compared, selected, and combined in various ways. For example, the training sets may be paired off and combined in pairs in a manner similar to that described for the two training set embodiments and examples. As another example, in some embodiments, the training sets from more than two or all of the trainers may be compared, pairs selected, and combined. For example, if a training set from Diane is compared against the training sets of Alicia, Bob, and Charles, there may be pairs selected that represent training context-action pairs from various combinations such as Diane:Alicia, Diane:Bob, and Diance:Charles. If this comparison is performed among all of the sets of training context-action pairs, then the possible combined pairs could be from all (or some subset of) combinations of Alicia, Bob, Charles, and Diane.

In some embodiments, the two received 110 and 120 context-action pairs can be combined and merged, can be mutated, etc. An example of a single cross-over or combination might have two context-action pairs that were determined to be the closest between Alicia and Bob (or are selected for some other reason), and therefore are being crossed-over:

| | Alicia | Bob |
|---|---|---|
| Left lane (“LL”, Boolean) | 1 | 1 |
| Left Turn Signal On (“LT”, | 1 | 1 |
| Boolean) | | |
| Distance to Light (“DTL”) | 120′ | 110′ |
| Speed of vehicle, MPH | 15 | DTL/10 |
| Action to be taken | Turn left at 0.7° | Turn left at 0.7° |

Combining these two training sets could take all identical elements between the two, and keep those. For the non-identical elements, the DTL and speed, one or the other might be chosen (at random or based on some other criteria), a random number between the two might be chosen, etc.

In various embodiments, candidate data can also be mutated (before, after, or as part of determining 130). For example, one or more of elements of the context or action may be mutated. This can be advantageous to give the population extra variance. Continuing the example above, if the resultant training case after mixing Alicia and Bob above was written on the left, it might be mutated as shown on the right below:

| | Result of | |
|---|---|---|
| | cross-over between | |
| | Alicia and Bob | After mutation |
| Left lane (“LL”, Boolean) | 1 | 1 |
| Left Turn Signal On (“LT”, | 1 | 1 |
| Boolean) | | |
| Distance to Light (“DTL”) | 112.5′ | 99′ |
| Speed of vehicle, MPH | 7.5 + DTL/20 | Speed = 1 + DTL/11 |
| Action to be taken | Turn left at 0.7° | Turn left at MAX (30°, |
| | | 50/DTL°) |

As depicted, the mutation can be of the context and/or the action to be taken. Further, mutations can include replacing numbers or constants with functions and/or variables, and vice-versa, as well as replacing numbers with numbers or functions with functions. Such functions can be based on, for example, one of the context variables. As depicted above, the speed and action to be taken were each mutated to a function of DTL. In some embodiments, mutations may also include removing actions (leaving the action empty or making the action a NULL), as well as mutating NULL or empty actions to include an action.

Mutations may be done randomly, or based on “seeding” the system with various parameters. For example, those working on the system, such as programmers, operators, trainers, etc. may know that the angle of a turn should increase and the speed should decrease the closer a vehicle gets to making a turn, but not know which function is correct. So, they may provide seed functions or general constraints, and the system may “experiment” with various functions that use those seed function and/or meet those general constraints. For example, the system may be seeded with various functions or portions of functions for turn angle, for example, the system could be seeded that the turn angle is likely the function of one or more of sin(speed), cos(speed), 1/speed, 1/DTL, speed, DTL, min(0°), max(30°), etc. Then the system could insert one or more of these elements to make functions for the left turn angle. This could be done while taking into account the candidate training data (Alicia's, Bob's, or a mixture thereof), or may be independent of the candidate training data.

In some embodiments, the mutations are a resampling of numbers in the context and/or action. For example, the resampling of numbers in the context and/or action may simply be varying the training set numbers using any function, including: sampling within a set percent, sampling the numbers over the observed range of the numbers, or resampling using a maximum entropy distribution with a mean at the number from the original training case. As an example of maximum entropy distribution, if a number from the context or action is known to be nonnegative but no other domain knowledge is known about the distribution of that number in other contexts/actions, a resample may consist of drawing a random number from the maximal entropy distribution for a nonnegative number for a given mean, namely an exponential distribution, whose mean is represented by the original number from the context or action. For example, just looking at the sample from Alicia, the distance to the light might be resampled using a maximum entropy distribution with mean of 120′, which might result in a DTL of 112.5′. Further, if the training set has certain observed properties, then the mutated number may be constrained to meet those properties. For example, if observed values are positive, the system may maintain the mutated value as a positive value. If the observed values are integers, the system may maintain the mutated value as an integer.

If something is known about the domain, it can be used in the system to hold the mutations within those known constraints. As such, in some embodiments, the system can allow a domain expert to constrain parts of the context and/or the action. For example, if it is known that Left Lane (LL) is Boolean, then the system can constrain any mutations to being either 0 or 1 (or True or False, depending on the implementation).

In some embodiments, the system may include per-context-field modifiers or constraints. These can be the same or different between training sets. These modifiers might act on the data in the training data. Such actions might be a Get (e.g., clamp), Mutate (e.g., force resampling in a certain range), or Mix (e.g., average for two inputs, return one or the other), or another function or constraint. These modifiers can be useful in instances where one might want to override the default way in which the system operates. Further, modifiers might be useful, for example, when you want the training data set to abide by certain constraints, even if the experts or trainers did not abide by those constraints. One such example is abiding by speed limits or norms. Modifiers might be used to clamps the speed of the training drivers. For example, Alicia's training set may have a modifier that clamps speed between 0 and 50 MPH, and Bob may have the same constraint, or a different constraint such as clamping speed between −10 and 45 MPH. Any training value outside those constraints may be clamped back to those values. When the modifiers are the same between two candidate training sets being combined, the system may simply include the modifier unchanged. If they are different, then the modifiers might be mixed or bred in a manner similar to that described the above. For example, the modifier for Alicia and Bob's speed might be averaged (clamp between −5 and 47.5 MPH) or resampled in any other way. Modifiers might also be mutated in manners similar to that described above.

In some embodiments, when two context-action pairs are mixed or bred as part of determining 130, or elsewhere, a portion of each is used, resulting in a “whole” or 100% context-action pair. For example, in a particular instance, the system may use 40% of Alicia's context-action pair and 60% of Bob's, resulting in a 100% or whole context-action pair. In some embodiments, the resulting context-action pair may be constructed based on more (or less) than 100% combined. For example, the system may use a combined 110% (70% Alicia and 40% Bob), or more, of the candidate context-action pairs. Using more than 100% combined context-action pair may be advantageous when the evolutionary aspects of the mutation might remove portions of the context and/or action, remove a link between the context and the action, and/or make part of the context invalid. For example, the mutation might remove the indication of LL, or Left Lane, from the context. If it turns out that the removed portion of the context is actually needed for proper performance, it could be useful for there to be a way to reintroduce elements, such as using more than 100% combined of the candidate training sets. Generally, combining together more than 100% of two candidate training context-action pairs, might be implemented as a Boolean “OR” of the two training context-action pairs in order to maintain any pieces that are unique to each context-action pair, or possibly 80-100% of the Boolean OR of the two trees. Further, in some embodiments, it will be useful to keep all of both sets of each context-action pair, notwithstanding that there could be some duplication of context variables.

After determining 130 the candidate context-action pair(s), a determination can be made whether more 140 context-action pairs remain to be combined. As discussed with respect to FIG. 2, and elsewhere herein, the selection of which candidate context-action pairs to combine may be based on a comparison among available context-action pairs. Further, the examples herein discuss primarily using training context-action pairs as the source for combination in FIG. 1 and FIG. 2, but any context-action pairs can be combined and evolved. For example, after a set of context-action pairs has been evolved by the techniques herein, those context-action pairs can be used as “input” for the system and further evolved. Additionally, those sets of context-action pairs may be combined with other evolved sets of training context-action pairs or original training data.

If there are more 140 context-action pairs to combine, the process 100 returns to 110. If not, a set of candidate context-action pairs are completed 150. If more 160 sets of context-action pairs remain to be evolved (including evolving the same sets again, evolving the product of previous evolutions, etc.), then the process 100 returns to 110, otherwise process 100 ends 170.

### Selecting Evolved Code for Computer-Based Reasoning Systems

FIG. 2 depicts a process 200 for selecting evolved code for computer-based reasoning systems. As discussed above, process 200 includes receiving 210 sets of context-action pairs, evolving 220 them, optional testing 230 the fitness of the evolved sets, and if exit criteria are reached 240, then selecting 250 one or more sets of candidate context-action pairs as the evolved set(s).

Receiving 210 the sets of training context-action pairs may happen in the same way or in different ways for each received 210 set. For example, each set of context-action pairs may be received from an evolution control engine 310 of FIG. 3, or some other process, program, or system. The sets of context-action pairs may be accessed from a memory in evolution control engine 310, attached storage 330 or 340, and may be received from a transmission over network 390. Further, as discussed elsewhere herein, the sets of context-action pairs received 210 may be training data, or may be sets of context-action pairs previously evolved using the techniques herein.

The sets of training data received 210 may be from individual trainers, such as Alicia and Bob from many of the examples herein, may be previously-evolved training sets made using the techniques herein, or may have been generated or received in some other manner.

Once sets of training data are received 210, those training sets may be evolved 220. The evolution 220 of the training data may be done using techniques described herein, such as those described with respect to process 100 of FIG. 1. Additionally, evolution of training data can take many forms and may involve the combination of training sets in various manners. For example, a single training set of context-action pairs could be evolved on its own or two or more sets of context-action pairs could be combined.

Evolving a single training set or multiple training sets together may take many forms. Consider, for example, training data from individual trainers. Each trainer may have much training data for each training run. In some embodiments, for each set of training data, all pairs of training data from each (parent) training set might be combined as part of the evolutionary experiments to produce a candidate training set. For example, if Bob has B total context-action pairs in a training set, and Alicia has A total pairs, combining all pairs could result in A*B total training pairs in an evolution 220. In some embodiments, only the N closest might be combined (e.g., resulting in A*N, B*N, or (A+B)*N total sets) as part of an evolution 220. As an additional example, each case in A may be evaluated with cases in B (either as an NA2 algorithm or via some indexing or hashing scheme by which it only needs to compare a much smaller number). If there is a match (by whatever criteria), those may be combined as part of the evolution 220. If not, techniques may consider keeping the unmatched context-action pair as part of the evolution. The same may be the case for those in the B (Bob's) set. In another example, if the subsets a and b represent the fraction of A and B that are chosen for combination, respectively, the number of resultant context-action pairs may be on the order of a+b−(a*b). In some embodiments, the candidate training sets may be mutated before combination or the result may be mutated after combination.

It can be advantageous to compare more training cases (e.g., where all training pairs from Alicia and Bob are combined) in order to have more candidate data to work from. It can also be advantageous to have fewer cases, for example, to reduce search time when matching current contexts to training contexts and/or to reduce computation time to compute or determine the evolved training cases. For example, with A and B cases as above, comparing all cases exhaustively will take O(A*B), but if a search among A cases is O(log(A)), then matching the closest cases from A to cases in B can take O(log(A)*B). In some embodiments, it will be a requirement that the context and/or action in a context-action pair is identical or similar in order for two training cases to be matched. For example, it can be the case that if the action is empty or NULL in one context-action pair, then it could be a requirement that the action is empty or NULL in any matched context-action pair. This can be advantageous to ensure that the different contexts in which a particular action might be taken can be evolved together.

After the sets of context-action pairs are evolved 220, a fitness of the sets of evolved context-action pairs can be optionally tested 230 for fitness. The fitness function may be any appropriate function. In some embodiments, the fitness function depends on the domain of the sets of evolved context-action pairs and can be a measure of performance of the sets of evolved context-action pairs as compared to other sets of evolved context-action pairs. For example, the fitness function may be a measure of speed, processing efficiency, or some other measure of performance. Further, the fitness score might be modified at random, to introduce additional variation. The fitness score may also be calculated based in part on fitness scores of “parent” sets of evolved context-action pairs. For example, if a set of evolved context-action pairs has parent sets of context-action pairs A′, A″ and B′, B″ going back two “generations”, then the fitness score may be a function of the current set of context-action pairs fitness and the fitness scores of A′, A″, B′, and B″. Further, the effect or contribution of the patents' and other ancestor fitness scores may phase out over time. For example, in some embodiments, the parents' fitness score may be multiplied by a coefficient less than one and added to the current fitness score multiplied by one minus the first coefficient. Since the scores from the generation(s) before the parents' would have also been included in the parents' scores and multiplied by a coefficient less than one, those scores would be further reduced in impact in the current and each subsequent generation. An example equation would be Score[i]=(1−B)*Fitness[i]+B*Sumⱼ(Scores[i−1,j]), where Fitness[i] is the current fitness score, 0≤B≤1, and Score[i−1,j] is the (j) parents' scores. Additionally, if a candidate set of context-action pairs remains or is otherwise a candidate for more than one generation, its own fitness score from previous generations may also be used in addition to its fitness score from the current generation. For example, a current fitness score may be a weighted sum of the fitness score from the current generation and the fitness score from the previous generation, such as 0.5*current_generation_fitness+0.5*previous_generation_fitness. For example, in the example of Alicia and Bob driving training above, the fitness function may be a function of one or more of travel time, smoothness of ride, whether there were any accidents or errors, etc.

If exit criteria are reached 240 by one or more of the sets of candidate context-action pairs, then those one or more sets (or perhaps others) may be selected 250 as the evolved or candidate sets of context-action pairs. The testing 230 for fitness is optional, but may be used in the exit criteria. Other exit criteria may include execution of a certain number of iterations of processes 100 and/or 200, passage of a certain amount of time, CPU utilization threshold being met, existence of a certain number and or type of context-action pairs, some other criteria or goal being met, etc. The exit criteria may be a combination of one or more of these.

When the exit criteria are reached 240, the evolved or candidate sets of context-action pairs can then be used in production, as part of a self-driving car reasoning engine, simulator, game, program, or may be further tested or evolved by techniques herein or other means, etc. If the exit criteria are not reached 240, the set(s) of candidate context-action pairs can be evolved again using process 100, 200, etc., discarded, and/or other sets of context-action pairs can be introduced (e.g., received 210) and evolved with or instead of the instant sets of context-action pairs as part of process 200.

### Example System for Evolving Computer-Based Reasoning Systems

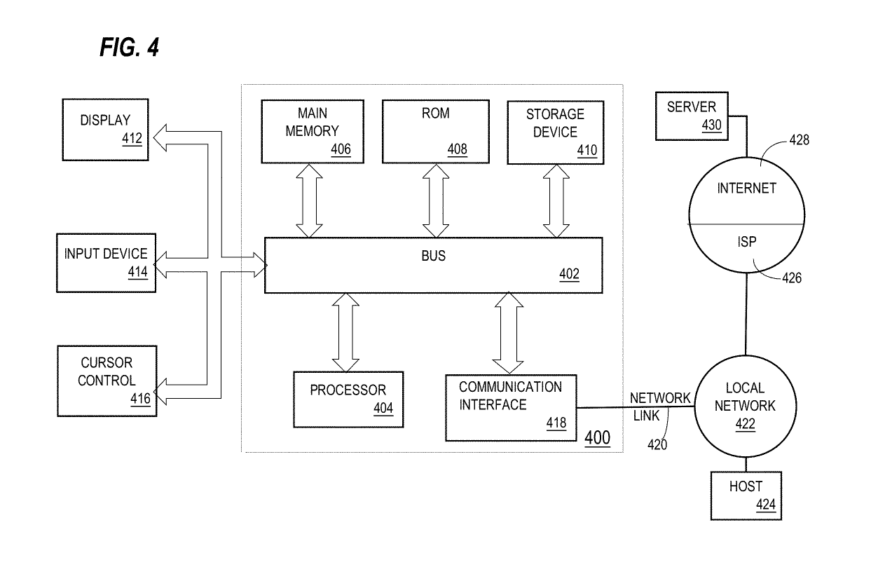

FIG. 3 depicts a block diagram of a system for evolving computer-based reasoning systems. System 300 includes a number of elements connected by a communicative coupling or network 390. Examples of communicative coupling and networks are described elsewhere herein. In some embodiments, the processes 100 and 200 of FIGS. 1 and 2 may run on the system 300 of FIG. 3 and/or the hardware 400 of FIG. 4. For example, the receiving 110, 120, 210 in FIG. 1 may be handled at evolution control engine 310 as well as determining 130 140, 160, 240 evolving 220, and testing 230. The resultant set(s) of context-action pairs might be made selected 250 by being stored at evolution control engine 310 and/or communicatively coupled storage 330 or 340. A resultant process control engine 320 may execute the selected 250 sets of context-action pairs produced by processes 100 and 200.

Each of evolution control engine 310 and resultant process control engine 320 may run on a single computing device, multiple computing devices, in a distributed manner across a network, on one or more virtual machines, which themselves run on one or more computing devices. In some embodiments, evolution control engine 310 and resultant process control engine 320 are distinct sets of processes running on distinct sets of computing devices. In other embodiments, evolution control engine 310 and resultant process control engine 320 are intertwined or share processes or functions and/or run on the same computing devices. In some embodiments, storage 330 and 340 are communicatively coupled to evolution control engine 310 and resultant process control engine 320 via a network 390 or other connection. Storage 330 and 340 may also be part of or integrated with evolution control engine 310 and/or resultant process control engine 320 via a network 390 or other connection.

As discussed herein the various processes 100, 200, etc. may run in parallel, in conjunction, together, or one process may be a subprocess of another. Further, any of the processes may run on the systems or hardware discussed herein.

### Hardware Overview

According to some embodiments, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as an OLED, LED or cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane. The input device 414 may also have multiple input modalities, such as multiple 2-axes controllers, and/or input buttons or keyboard. This allows a user to input along more than two dimensions simultaneously and/or control the input of more than one type of action.

Computer system 400 may implement the techniques described herein using customized hard-wired logic, one or more ASICs or FPGAs, firmware and/or program logic which in combination with the computer system causes or programs computer system 400 to be a special-purpose machine. According to some embodiments, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information. Such a wireless link could be a Bluetooth, Bluetooth Low Energy (BLE), 802.11 WiFi connection, or the like.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A non-transitory computer readable medium storing instructions which, when executed by one or more computing devices, cause the one or more computing devices to perform a process of:
receiving a first training context-action pair, wherein the first training context-action pair comprises first one or more context elements, first one or more action elements representing actions taken in a first training context represented by the first one or more context elements, and at least one first executable context element;
receiving a second training context-action pair, wherein the second training context-action pair comprises second one or more context elements, and second one or more action elements representing actions taken in a second training context represented by the one or more context elements;
evolving a candidate context-action pair based at least in part on the first training context-action pair and the second training context-action pair by:
evolving the first one or more context elements and the second one or more context elements to produce candidate one or more context elements;
evolving the first one or more action elements and the second one or more action elements to produce candidate one or more action elements;
creating the candidate context-action pair based on the candidate one or more context elements and the candidate one or more action elements;
testing whether a set of candidate context-action pairs meets exit criteria, wherein the set of candidate context-action pairs includes the candidate context-action pair;
in response to determining that the set of candidate context-action pairs meets the exit criteria, selecting the set of candidate context-action pairs as an evolved set of candidate context-action pairs.

2. The non-transitory computer readable medium of claim 1, wherein determining the candidate context-action pair based at least in part on the first training context-action pair and the second training context-action pair comprises mutating a portion of the candidate context-action pair.

3. The non-transitory computer readable medium of claim 2, wherein mutating the portion of the candidate context-action pair comprises replacing the portion of the candidate context-action pair with a function.

4. The non-transitory computer readable medium of claim 3, wherein the function is calculated based on a second portion of the candidate context-action pair different from said portion of the candidate context-action pair.

5. The non-transitory computer readable medium of claim 1, wherein the candidate context-action pair comprises at least one candidate executable context element and the process further comprises determining the at least one candidate executable context element of the candidate context-action pair based at least in part on the at least one first executable context element.

6. The non-transitory computer readable medium of claim 1, wherein the process further comprises receiving a third training context-action pair and wherein evolving the candidate context-action pair comprises evolving the candidate context-action pair based at least in part on the first training context-action pair, the second training context-action pair, and the third training context-action pair.

7. The non-transitory computer readable medium of claim 1, wherein determining the candidate context-action pair based at least in part on the first training context-action pair and the second training context-action pair comprises selecting randomly between the first training context-action pair and the second training context-action pair.

8. The non-transitory computer readable medium of claim 1, wherein determining the candidate context-action pair based at least in part on the first training context-action pair and the second training context-action pair comprises performing a resampling based at least in part on a context element of the first training context-action pair and a context element of the second training context-action pair.

9. The non-transitory computer readable medium of claim 1, wherein determining the candidate context-action pair based at least in part on the first training context-action pair and the second training context-action pair comprises comparing modifiers associated with on the first training context-action pair and the second training context-action pair.

10. The non-transitory computer readable medium of claim 1, wherein testing whether the set of candidate context-action pairs meets the exit criteria comprises determining a fitness score for the set of candidate context-action pairs.

11. The non-transitory computer readable medium of claim 1, wherein when the exit criteria are not met, the set of candidate context-action pairs is used as a training set, and is further evolved.

12. The non-transitory computer readable medium of claim 1, wherein the first training context-action pair and the second training context-action pair are part of one or more sets of training context-action pairs, and the process performed by the one or more computing devices further comprises:
comparing two or more training context-action pairs in the one or more sets of training context-action pairs; and
selecting the first training context-action pair and the second training context-action pair based at least in part on the comparison of the two or more training context-action pairs in the one or more sets of training context-action pairs.

13. A method comprising:
receiving a first training context-action pair, wherein the first training context-action pair comprises first one or more context elements, first one or more action elements representing actions taken in a first training context represented by the first one or more context elements, and at least one first executable context element;
receiving a second training context-action pair, wherein the second training context-action pair comprises second one or more context elements, and second one or more action elements representing actions taken in a second training context represented by the one or more context elements;
evolving a candidate context-action pair based at least in part on the first training context-action pair and the second training context-action pair by:
evolving the first one or more context elements and the second one or more context elements to produce candidate one or more context elements;
evolving the first one or more action elements and the second one or more action elements to produce candidate one or more action elements;
creating the candidate context-action pair based on the candidate one or more context elements and the candidate one or more action elements;
testing whether a set of candidate context-action pairs meets exit criteria, wherein the set of candidate context-action pairs includes the candidate context-action pair; and
in response to determining that the set of candidate context-action pairs meets the exit criteria, selecting the set of candidate context-action pairs as an evolved set of candidate-action pairs,
wherein the method is performed by one or more computing devices.

14. The method of claim 13, wherein determining the candidate context-action pair based at least in part on the first training context-action pair and the second training context-action pair comprises mutating a portion of the candidate context-action pair.

15. The method of claim 14, wherein mutating the portion of the candidate context-action pair comprises replacing the portion of the candidate context-action pair with a function.

16. The method of claim 15, wherein the function is calculated based on a second portion of the candidate context-action pair different from said portion of the candidate context-action pair.

17. The method of claim 13, wherein the second training context-action pair comprises at least one second executable context element.

18. The method of claim 17, wherein an executable element of the candidate context-action pair is determined based at least in part on the at least one second executable context element.

19. A system for performing a machine-executed operation involving instructions, wherein said instructions are instructions which, when executed by one or more computing devices, cause performance of a process including:
receiving a first training context-action pair, wherein the first training context-action pair comprises first one or more context elements, first one or more action elements representing actions taken in a first training context represented by the first one or more context elements, and at least one first executable context element;
receiving a second training context-action pair, wherein the second training context-action pair comprises second one or more context elements, and second one or more action elements representing actions taken in a second training context represented by the one or more context elements;
evolving a candidate context-action pair based at least in part on the first training context-action pair and the second training context-action pair by:
evolving the first one or more context elements and the second one or more context elements to produce candidate one or more context elements;
evolving the first one or more action elements and the second one or more action elements to produce candidate one or more action elements;
creating the candidate context-action pair based on the candidate one or more context elements and the candidate one or more action elements;
testing whether a set of candidate context-action pairs meets exit criteria, wherein the set of candidate context-action pairs includes the candidate context-action pair; and
in response to determining that the set of candidate context-action pairs meets the exit criteria, selecting the set of candidate context-action pairs as an evolved set of candidate-action pairs.

20. The system of claim 19, wherein when the exit criteria are not met, the set of candidate context-action pairs is used as a training set, and is further evolved.

21. The non-transitory computer readable medium of claim 1, wherein the process further comprises:
receiving an input context for a controlled system;
determining one or more suggested context-action pairs from among the evolved set of candidate context-action pairs by comparing the set of candidate context-action pairs to the input context;
causing control of the controlled system based on the one or more suggested context-action pairs.

22. The method of claim 13, further comprising:
receiving an input context for a controlled system;
determining one or more suggested context-action pairs from among the evolved set of candidate context-action pairs by comparing the set of candidate context-action pairs to the input context;
causing control of the controlled system based on the one or more suggested context-action pairs.

23. The system of claim 19, wherein the process further comprises:
receiving an input context for a controlled system;
determining one or more suggested context-action pairs from among the evolved set of candidate context-action pairs by comparing the set of candidate context-action pairs to the input context;
causing control of the controlled system based on the one or more suggested context-action pairs.
